(19) United States
(12) Patent Application Publication
(10) Pub. No.: US 2019/0066301 A1
(43) Pub. Date: Feb. 28, 2019

(54) METHOD FOR SEGMENTATION OF AN ORGAN STRUCTURE OF AN EXAMINATION OBJECT IN MEDICAL IMAGE DATA

(71) Applicant: Siemens Healthcare GmbH, Erlangen (DE)

(72) Inventor: Rene KARTMANN, Nuernberg (DE)

(73) Assignee: Siemens Healthcare GmbH, Erlangen (DE)

(21) Appl. No.: 16/110,076

(22) Filed: Aug. 23, 2018

(30) Foreign Application Priority Data
Aug. 30, 2017 (EP) 17188583.3

(51) Int. Cl. G06T 7/11; G06T 7/155; G06T 7/149

(52) U.S. Cl. CPC G06T 7/11; G06T 7/155; G06T 7/149; G06T 2207/20036; G06T 2207/30048; G06T 2207/20084; G06T 2207/20081; G06T 2207/30016; G06T 2207/30081; G06T 2207/20128

(57) ABSTRACT

A method for segmentation of an organ structure of an examination object in medical image data, a processing unit, a medical imaging device and a computer program product are disclosed. In an embodiment, the method, for segmentation of an organ structure of an examination object in medical image data, includes acquiring genetic data of an examination object, characterizing a morphological variation of an organ structure; acquiring medical image data from the examination object; segmenting the organ structure in the medical image data using a segmentation algorithm, wherein the genetic data is entered into the segmentation algorithm in addition to the medical image data, as input parameters, and wherein the segmentation algorithm takes account of morphological variation of the organ structure during the segmenting of the organ structure, to proce a segmented organ structure; and provisioning the segmented organ structure.

### PRIORITY STATEMENT

The present application hereby claims priority under 35 U.S.C. § 119 to European patent application number EP17188583.3 filed Aug. 30, 2017, the entire contents of which are hereby incorporated herein by reference.

### FIELD

Embodiments of the invention generally relates to a method for segmentation of an organ structure of an examination object in medical image data, a processing unit, a medical imaging device and/or a computer program product

### BACKGROUND

Medical image data is usually recorded via medical imaging devices and can represent anatomical structures and/or functional processes of a body of a patient. The segmentation of medical image data is one of the most frequently used methods for post-processing of medical image data. An organ structure segmented in the medical image data can represent the basis for a computer-assisted evaluation of the medical image data. Thus for example an automatic recognition of pathologies of the organ structure on the basis of morphological parameters recognized in the segmentation is conceivable. The segmentation of the organ structure can further represent the basis for a visualization of the organ structure. Frequently the automatic segmentation of a target organ and/or organ at risk is also able to be used meaningfully in the workflow of planning a radiation therapy.

Various algorithms for automatic computer-assisted segmentation of organ structures in medical image data are known. These algorithms naturally provide the medical image data itself or information derived from the medical image data, for example texture parameters, as input parameters. Furthermore patient-specific characteristics, such as for example a size, an age or a gender of the patient, can be entered as input data into the segmentation algorithm. For example in an atlas-based segmentation a suitable atlas for segmentation of an organ structure can be selected on the basis of the gender of the patient. Various methods for segmentation of medical image data are known for example from US 20170011526 A1, U.S. Pat. No. 8,170,330 B2, U.S. Pat. No. 8,837,771 B2 or U.S. Pat. No. 9,367,924 B2.

There is currently very rapid further development of molecular diagnostic methods, so that an analysis of the human genome demands less and less time and is becoming more cost effective. In this way routine availability of genetic data for individual patients will be far greater in the future. In this way genetic data as well as medical image data can be available from a patient, so that a complex disease picture can be investigated in such cases by way of different diagnostic parameters.

### SUMMARY

At least one embodiment of the invention makes possible a segmentation of an organ structure of the examination object that is effective and specifically tailored to an examination object. Advantageous embodiments are described in the claims.

The inventive method of at least one embodiment, for segmentation of an organ structure of an examination object in medical image data, comprises:

acquisition of genetic data of the examination object, which characterizes a morphological variation of the organ structure,

acquisition of medical image data from the examination object,

segmentation of the organ structure in the medical image data by way of a segmentation algorithm, wherein the genetic data is entered into the segmentation algorithm in addition to the medical image data as input parameters and wherein the segmentation algorithm takes account of the morphological variation of the organ structure during the segmentation of the organ structure, and

provision of the segmented organ structure.

At least one embodiment of the inventive processing unit comprises at least one processing module, wherein the processing unit is embodied for carrying out at least one embodiment of an inventive method.

At least one embodiment of the processing unit in particular is embodied to execute computer-readable instructions, in order to carry out at least one embodiment of the inventive method. In particular, at least one embodiment of the processing unit comprises a memory unit, wherein computer-readable information is stored on the memory unit, wherein the processing unit is embodied to load the computer-readable information from the memory unit and to execute the computer-readable information in order to carry out at least one embodiment of an inventive method.

In this way, at least one embodiment of the inventive processing unit is embodied to carry out a method for segmentation of an organ structure of an examination object in medical image data. For this the processing unit can comprise a first acquisition unit for acquisition of genetic data of the examination object, which characterizes a morphological variation of the organ structure. The processing unit can comprise a second acquisition unit for acquisition of medical image data from the examination object. The processing unit can comprise a segmentation unit for segmentation of the organ structure in the medical image data by way of a segmentation algorithm, wherein the genetic data is entered into the segmentation algorithm in addition to the medical image data as input parameters and wherein the segmentation algorithm takes account of the morphological variation of the organ structure during the segmentation of the organ structure. The processing unit can comprise a provision unit for provision of the segmented organ structure.

At least one embodiment of the inventive medical imaging device comprises at least one embodiment of the inventive processing unit.

At least one embodiment of the processing unit can be embodied to send control signals to the medical imaging device and/or to receive control signals and/or to process them, in order to carry out at least one embodiment of an inventive method. The processing unit can be integrated into the medical imaging device. The processing unit can also be installed separately from the medical imaging device. The processing unit can be connected to the medical imaging device.

At least one embodiment of the inventive computer program product is able to be loaded directly into a memory of a programmable processing unit and has program code segments for carrying out at least one embodiment of an inventive method when the computer program product is executed in the processing unit. The computer program product can be a computer program or can comprise a computer program. This enables at least one embodiment of the inventive method to be carried out quickly, in an identically repeatable manner and robustly.

At least one embodiment of the computer program product is configured so that it can carry out at least one embodiment of the inventive method steps via the processing unit. To do this the processing must have the preconditions in this case, such as for example a corresponding main memory, a corresponding graphics card or a corresponding logic unit, so that the respective method steps can be carried out efficiently.

The computer program product, in at least one embodiment, is stored on a computer-readable medium for example or is held on a network or server, from it can be loaded into the processor of a local processing unit, which can be connected directly to it or be part of it. Furthermore control information of the computer program product can be stored on an electronically-readable data medium. The control information of the electronically-readable data medium can be embodied so as to carry out at least one embodiment of an inventive method when the data medium is used in a processing unit. Thus the computer program product can also represent the electronically-readable data medium.

Examples of electronically-readable data media are a DVD, a magnetic tape, a hard disk or a USB stick, on which electronically-readable control information, in particular software (cf. above), is stored. When this control information (software) is read from the data medium and stored in a controller and/or processing unit, all inventive forms of embodiments of the method previously described can be carried out. Thus, at least one embodiment of the invention can also be based on the computer-readable medium and/or the electronically-readable data medium.

### BRIEF DESCRIPTION OF THE DRAWINGS

The invention will be described and explained in greater detail below on the basis of the example embodiments shown in the figures.

In the figures:

FIG. 1 shows a medical imaging device with an embodiment of an inventive processing unit,

FIG. 2 shows a first form of embodiment of an inventive method,

FIG. 3 shows a second form of embodiment of an inventive method

FIG. 4 shows a first possible application of an embodiment of an inventive method,

FIG. 5 shows a second possible application of an embodiment of an inventive method,

FIG. 6 shows a third possible application of an embodiment of an inventive method and

FIG. 7 shows a fourth possible application of an embodiment of an inventive method.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or porcessors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (procesor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

The inventive method of at least one embodiment, for segmentation of an organ structure of an examination object in medical image data, comprises:

acquisition of genetic data of the examination object, which characterizes a morphological variation of the organ structure,

acquisition of medical image data from the examination object,

segmentation of the organ structure in the medical image data by way of a segmentation algorithm, wherein the genetic data is entered into the segmentation algorithm in addition to the medical image data as input parameters and wherein the segmentation algorithm takes account of the morphological variation of the organ structure during the segmentation of the organ structure, and

provision of the segmented organ structure.

The organ structure in such cases can be an entire body organ of the examination object or can be a part of a body organ of the examination object. The examination object can be a patient, a healthy test subject or an animal. The acquisition of the medical image data can comprise acquisition of the medical image data via a medical imaging device or loading of already acquired medical image data from an image database.

The acquisition of the genetic data can comprise an analysis of the genome of the examination object, for example by way of a gene sequencing method, or loading of already analyzed genetic data of the examination object from a database. The genetic data in particular relates to the specific hereditary characteristics for the examination object, for example a part of a DNA sequence of the examination object or a part of the genetic fingerprint of the examination object. The actual genetic data acquired from the examination object can thus depend on the clinical problem, in particular the organ structure to be segmented.

The acquisition of the genetic data can comprise a specific genetic marker being established for the examination object, which can be used in a suitable manner as input parameter for the segmentation algorithm. In particular genetic data of the examination object will be acquired, which relates specifically to a morphology, for example a size and/or a shape of the organ structure to be segmented. In this way the genetic data can for example characterize whether or to what extent the organ structure is affected by the morphological variation. The morphological variation of the organ structure in this case is in particular a change of a morphology, i.e. for example of a size and/or shape of the organ structure, compared to a standard morphology of the organ structure.

The acquisition of the genetic data in this case can comprise a check as to whether a particular genetic variant, which leads to the morphological variation of the organ structure, is present in the genetic data of the examination object. The genetic variant, also called the gene variant, in this case is in particular a change of a DNA sequence of the examination object compared to a standard DNA sequence, for example in an area between genes (intergenetic variant).

The segmentation of the organ structure comprises in particular an automatic or semi-automatic recognition of the organ structure in the medical image data. The segmentation of the organ structure can comprise a determination of which part of the medical image data the organ structure is to be assigned. In this way the segmentation of the organ structure in particular comprises a definition for each voxel of medical image data as to whether the voxel belongs to the organ structure or not. The segmentation of the organ structure in this case is carried out in particular by the segmentation algorithm. The segmentation algorithm in this case can employ a known segmentation method, for example an atlas-based segmentation, a random walker method, a region growing method or a use of an artificial neural network.

Further segmentation methods are possible, for example an active contours segmentation method (e.g. active snakes), a level set segmentation method, or a statistical segmentation method (e.g. active shape models). Naturally further segmentation methods appearing sensible to the person skilled in the art are conceivable. In a semi-automatic segmentation the user can initialize the segmentation, for example via the setting of a seed point and/or via the setting of at least one landmark. The user can also check and/or modify the segmentation that has taken place.

The segmentation algorithm has as its input parameters both the medical image data and also the genetic data. The fact that the segmentation algorithm has the genetic data as its input parameters can also mean that the segmentation algorithm has as its input parameters information derived from the genetic data of the examination object, in particular in relation to the morphological variation of the organ structure. The morphological variation of the organ structure is taken into account in particular based on the genetic data, which specifies for example whether and to what extent the organ structure is affected by the morphological variation.

The genetic data and the morphological variation of the organ structure liked thereto can thus represent especially advantageous additional information for the segmentation of the organ structure. As described in greater detail in the forms of embodied set out below, in accordance with the genetic data the segmentation algorithm can be selected or adapted in an especially suitable manner. While taking account of the genetic data the segmentation of the organ structure can thus take place in a manner tailored to the examination object. In this way for example a more precise and/or more effective segmentation of the organ structure is conceivable.

Advantageously it is not only the image contents of the medical image data that is taken into account in the segmentation of the organ structure, but also a morphology of the organ structure characterized by the genetic data. For example it is conceivable in this way that the effort involved in processing the segmentation can be reduced if, on the basis of the morphological variation characterized by the genetic data, suitable boundary conditions for the segmentation can already be set.

The provision of the segmented organ structure comprises in particular an output of the segmented organ structure on an output unit, for example a display unit, and/or a storage of the segmented organ structure in a database. The segmented organ structure is provided in this case in particular in relation to the medical image data, for example is represented in the medical image data with suitable distinguishing features, e.g. color-coded. As an alternative or in addition the segmented organ structure can be transferred to a further processing unit, which, on the basis of the segmented organ structure, can carry out further processing of the medical image data. For the application case of planning an irradiation of the examination object, the segmented organ structure can be set as the target organ or organ at risk for radiation therapy planning.

The further processing of the medical image data or of the segmented organ structure can be undertaken in its turn using the genetic data. For example a standard range of values tailored to the morphological variation of the examination object can be defined for a morphology of the organ structure as a function of the genetic data. This standard range of values tailored to the genetic data can be used in a suitable manner in an automatic diagnosis of an abnormal morphology of the organ structure, which can point to a disease.

One form of embodiment provides for the morphological variation to relate to at least one of the following morphological features of the organ structure:
A size of the organ structure,
A shape of the organ structure,
A volume of the organ structure,
A localization of the organ structure in the body of the examination object.

In this way the segmentation algorithm, when the morphological variation is known from the genetic data, can take account in an especially suitable manner of the at least one morphological feature specific for the examination object. The morphological variation characterized by the genetic data can in this case comprise information about the extent to which the at least one morphological feature is affected by the morphological variation. This extent of the change of the at least one morphological feature can be specified in this case as absolute or relative to another organ structure or to a range of standard values for the morphological feature. A prior knowledge known from the genetic data about at least one of the morphological features can provide support as additional information in the segmentation of the organ structure.

One form of embodiment makes provision for the acquisition of the genetic data to comprises a check as to whether a genetic variant, which leads to the morphological variation of the organ structure, is present in the genetic data of the examination object, wherein a result of the check is entered as an input parameter into the segmentation algorithm and the segmentation algorithm takes account of the result of the check in the segmentation of the organ structure.

Typically the genetic variant, for example an intergenetic variant, leads to the morphological variation. This means in particular that only when the genetic variant is present in the genetic data is the organ structure affected by the morphological variation. In this way, by way of the check as to whether the genetic variant is present in the genetic data, the morphological variation of the organ structure can be determined in an especially advantageous manner. The result of the check in this case can in particular be binary information as to whether the genetic variant is present or not in the genetic data of the examination object. The binary information can in this way be included in a suitable manner as additional information in the segmentation of the organ structure. For example, on the basis of the binary information, the segmentation algorithm can be selected and/or a segmentation parameter of the segmentation algorithm set or adapted.

One form of embodiment makes provision for the organ structure type to be segmented in the medical image data to be defined first of all in a further method step, and wherein the check is carried out in accordance with the defined organ structure type.

In this way it is in particular first defined or determined which organ structure type, i.e. in particular which type of organ structure, is to be segmented and based on this definition a check is made as to whether a genetic variant is present in the genetic data of the patient, which specifically leads to a morphological change of the organ structure type to be segmented. In this way the genetic data of the examination object can be searched especially explicitly for the genetic variants decisive for the organ structure type.

As an alternative the procedure is also conceivable that a check is made before the segmentation independently of the organ structure type to be segmented as to whether a striking genetic variant, which can influence organ structures in their morphology, is present in the genetic data of the patient, so that accordingly there can be a suitable adaptation of the segmentation to be carried out.

One form of embodiment makes provision for the acquisition of the genetic data to comprise an acquisition of information about the extent to which the organ structure is changed by the morphological variation in its morphology, wherein the information is entered as input parameters in the segmentation algorithm and the segmentation algorithm takes account of the information in the segmentation of the organ structure.

In this way the segmentation algorithm can be adapted in an especially suitable manner in accordance with the extent of the change of the morphology of the organ structure by the morphological variation. The extent of the change can be specified in such cases as a percentage of standard values of the morphology of the organ structure.

One form of embodiment makes provision for the segmentation algorithm to employ an atlas-based segmentation using an atlas, wherein the atlas used for the segmentation is selected from a set of atlases in accordance with presence of the morphological variation characterized by the genetic data.

The set of atlases can comprise a first atlas and a second atlas, wherein the first atlas is based on atlas image data of a first atlas collective, which has a genetic variant linked to the morphological variation, and wherein the second atlas is based on atlas image data of a second atlas collective, which does not have a genetic variant linked to the morphological variation. In accordance with the presence of the genetic variant or the morphological variation of the organ structure the suitable atlas can then be selected for the segmentation of the organ structure from the set of atlases. The use of the atlas tailored to the morphological variation of the organ structure can make the atlas-based segmentation more precise and/or make it perform better.

One form of embodiment makes provision for the segmentation algorithm to employ an atlas-based segmentation using an atlas, wherein the atlas has at least one atlas organ structure and the atlas organ structure is deformed by the presence of the morphological variation characterized by the genetic data.

In this way initially a standard atlas or an atlas selected in a suitable manner in accordance with the previous form of embodiment can be employed. This atlas, before it is used for the segmentation, for example before its registration to the medical image data, can then be suitably adapted on the basis of the genetic data. For example at least one atlas organ structure in the atlas can be deformed in accordance with the morphological variation characterized by the genetic data. By way of the atlas adapted in this way a precise and/or high-performance atlas-based segmentation of the organ structure is possible.

One form of embodiment makes provision for the segmentation algorithm to employ a region growing method or a random walker method using a boundary condition for the segmentation of the organ structure, wherein the boundary condition is defined in accordance with the morphological variation characterized by the genetic data.

If the morphological variation specifies a change of at least one morphological feature, the change of the at least one morphological feature can represent a suitable boundary condition for the region growing method or the random walker method. The segmentation methods can give a better performance and provide more precise results through the use of the boundary condition.

One form of embodiment makes provision for the segmentation algorithm to employ an artificial neural network trained for the segmentation of the organ structure, wherein the artificial neural network used for the segmentation is selected and/or changed in accordance with the presence of the morphological variation characterized by the genetic data.

In this way the segmentation of the organ structure in particular is based on a machine learning method, also called a deep learning method, which is based on the artificial neural network. An artificial neural network (ANN) is in particular a network of artificial neurons emulated in a computer program.

The artificial neural network in this case is typically based on a networking of a number of artificial neurons. The artificial neurons in this case are typically arranged in different layers. Usually the artificial neural network comprises an input layer and an output layer, of which the neuron output is visible as the only output of the artificial neural network. Layers lying between the input layer and the output layer are typically referred to as hidden layers.

Typically an architecture and/or topology of an artificial neural network is first initiated and then trained in a training phase for a specific task or for a number of tasks. The training of the artificial neural network in such cases typically comprises a change in a weighting of a connection between two artificial neurons of the artificial neural network. The training of the artificial neural network can also comprise a development of new connections between artificial neurons, a deletion of existing connections between artificial neurons, an adaptation of threshold values of the artificial neurons and/or an insertion or a deletion of artificial neurons.

The artificial neural network has in particular already been suitably trained in advance for the segmentation of the organ structure. Medical training data records have been used in particular in this case for the training of the artificial neural network, in which the organ structure is present already segmented. The medical training data records in this case have typically been acquired from training examination objects different from the examination object.

By taking account of the genetic data, the segmentation by way of the artificial neural network can now be specifically tailored to the examination object. For example a suitably trained artificial neural network can be selected on the basis of the presence of a gene variant in the examination object, as is described in more detail in the form of embodiment below.

It is also conceivable for the trained artificial neural network to be suitably trained retrospectively on the basis of the genetic data, so that the artificial neural network can carry out the segmentation especially advantageously tailored to the morphological variation characterized by the genetic data. It is also conceivable for the genetic data or information derived from the genetic data to be taken into account as additional training parameters during training of the artificial neural network. In order to reduce the complexity, it is advantageous for example to derive from the genetic data a binary training parameter as to whether a specific gene variant is present in examination objects or not, and to use this in the training of the artificial neural network.

One form of embodiment makes provision for there to be a first artificial neural network and a second artificial neural network available for the segmentation of the organ structure, wherein the first artificial neural network to have been trained by way of a first training collective, which has the genetic variant, and for the second artificial neural network to have been trained by way of a second training collective, which does not have the genetic variant, wherein, in accordance with the result of the check, the first artificial neural network or the second artificial neural network is used for the segmentation of the organ structure.

If the result of the check is that the examination object has the genetic variant, then in particular the first artificial neural network is used for the segmentation. If the result of the check is that the examination object does not have the genetic variant, then in particular the second artificial neural network is used for the segmentation. The artificial neural network selected in this way can carry out the segmentation especially precisely and/or with high performance, since it has been selected especially suitably as tailored to the morphological variation characterized by the genetic data.

One form of embodiment makes provision for a further patient-specific feature of the examination object to be acquired, wherein the further patient-specific feature is included in the segmentation algorithm in addition to the medical image data and the genetic data and comprises at least one feature from the following list:
An age of the examination object,
A gender of the examination object,
A size of the examination object,
A weight of the examination object.

In this way the patient-specific feature can be included in the segmentation of the organ structure as especially advantageous further additional information. In this way the segmentation of the organ structure can be carried out tailored in an even more individual manner to the examination object.

One form of embodiment makes provision for the organ structure to be segmented to be one of the following organ structures:
A brain structure of the examination object,
A prostate of the examination object,
A heart structure of the examination object.

For the organ structures, at least one embodiment of the inventive method can be employed in an especially suitable manner. The brain structure can for example comprise one or more of the structures from the following list: Corpus callosum, hippocampus, cortex, thalamus, hypothalamus, brain stem, cerebellum, white brain matter, gray brain matter brain matter, Liquor cerebrospinalis, etc. The heart structure can for example comprise one or more of the structures from the following list: Right atrium, left atrium, right ventricle, left ventricle, aorta, pericard, myocard, epicard, cardiac apex, etc. Naturally other organ structures, which can be segmented by way of the inventive method, are conceivable.

At least one embodiment of the inventive processing unit comprises at least one processing module, wherein the processing unit is embodied for carrying out at least one embodiment of an inventive method.

At least one embodiment of the processing unit in particular is embodied to execute computer-readable instructions, in order to carry out at least one embodiment of the inventive method. In particular, at least one embodiment of the processing unit comprises a memory unit, wherein computer-readable information is stored on the memory unit, wherein the processing unit is embodied to load the computer-readable information from the memory unit and to execute the computer-readable information in order to carry out at least one embodiment of an inventive method.

In this way, at least one embodiment of the inventive processing unit is embodied to carry out a method for segmentation of an organ structure of an examination object in medical image data. For this the processing unit can comprise a first acquisition unit for acquisition of genetic data of the examination object, which characterizes a morphological variation of the organ structure. The processing unit can comprise a second acquisition unit for acquisition of medical image data from the examination object. The processing unit can comprise a segmentation unit for segmentation of the organ structure in the medical image data by way of a segmentation algorithm, wherein the genetic data is entered into the segmentation algorithm in addition to the medical image data as input parameters and wherein the segmentation algorithm takes account of the morphological variation of the organ structure during the segmentation of the organ structure. The processing unit can comprise a provision unit for provision of the segmented organ structure.

The components of at least one embodiment of the processing unit can be embodied for the predominant part in the form of software components. Basically however some of these components can be realized as software-supported hardware components, for example FPGAs or the like, in particular when it is a matter of especially fast calculations. Likewise the interfaces needed, when for example it is only a matter of transferring data from other software components, can be embodied as software interfaces. They can however also be embodied as interfaces constructed on the basis of hardware, which are controlled by suitable software. Naturally it is also conceivable for a number of the components to be realized grouped together in the form of individual software components or software-supported hardware components.

At least one embodiment of the inventive medical imaging device comprises at least one embodiment of the inventive processing unit.

At least one embodiment of the processing unit can be embodied to send control signals to the medical imaging device and/or to receive control signals and/or to process them, in order to carry out at least one embodiment of an inventive method. The processing unit can be integrated into the medical imaging device. The processing unit can also be installed separately from the medical imaging device. The processing unit can be connected to the medical imaging device.

The acquisition of the medical image data can comprise a recording of the medical image data via a recording unit of the medical imaging device. The medical image data can then be transferred to the processing unit for further processing. The processing unit can then acquire the medical image data via the second acquisition unit.

At least one embodiment of the inventive computer program product is able to be loaded directly into a memory of a programmable processing unit and has program code segments for carrying out at least one embodiment of an inventive method when the computer program product is executed in the processing unit. The computer program product can be a computer program or can comprise a computer program. This enables at least one embodiment of the inventive method to be carried out quickly, in an identically repeatable manner and robustly.

At least one embodiment of the computer program product is configured so that it can carry out at least one embodiment of the inventive method steps via the processing unit. To do this the processing must have the preconditions in this case, such as for example a corresponding main memory, a corresponding graphics card or a corresponding logic unit, so that the respective method steps can be carried out efficiently.

The computer program product, in at least one embodiment, is stored on a computer-readable medium for example or is held on a network or server, from it can be loaded into the processor of a local processing unit, which can be connected directly to it or be part of it. Furthermore control information of the computer program product can be stored on an electronically-readable data medium. The control information of the electronically-readable data medium can be embodied so as to carry out at least one embodiment of an inventive method when the data medium is used in a processing unit. Thus the computer program product can also represent the electronically-readable data medium.

Examples of electronically-readable data media are a DVD, a magnetic tape, a hard disk or a USB stick, on which electronically-readable control information, in particular software (cf. above), is stored. When this control information (software) is read from the data medium and stored in a controller and/or processing unit, all inventive forms of embodiments of the method previously described can be carried out. Thus, at least one embodiment of the invention can also be based on the computer-readable medium and/or the electronically-readable data medium.

The advantages of embodiments of the inventive computer program product, of embodiments of the inventive medical imaging device and of embodiments of the inventive processing unit essentially correspond to the advantages of embodiments of the inventive method, which have been set down above in detail. Features, advantages or alternate forms of embodiment mentioned here are likewise to be transferred into the other claimed subject matter and vice versa. In other words the physical claims can also be developed with the features that are described or claimed in conjunction with a method. The corresponding functional features of the method will be embodied in such cases by corresponding physical modules, in particular by hardware modules.

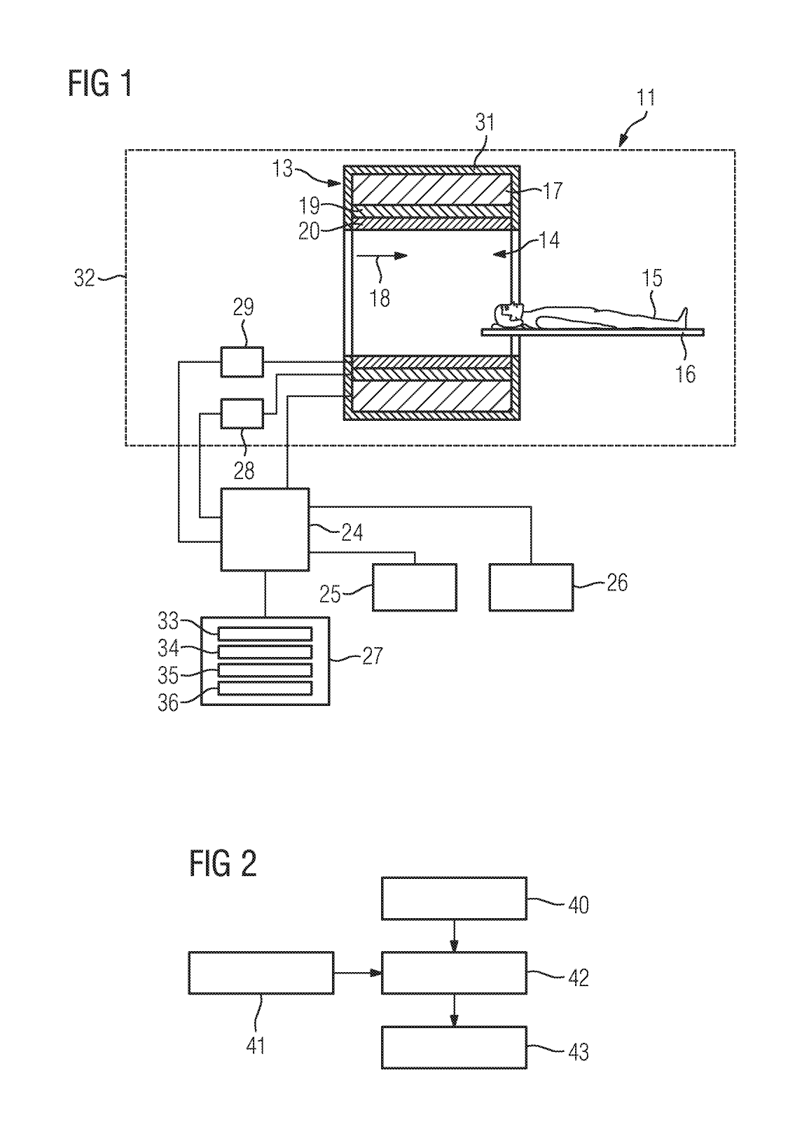

FIG. 1 shows a medical imaging device 11 with an inventive processing unit 27.

The medical imaging device 11 can for example be a magnetic resonance device, a Single Photon Emission Computed Tomography device (SPECT device), a Positron Emission Tomography device (PET device), a computed tomograph, an ultrasound device, an x-ray device or a C-arm device. Combined medical imaging devices 11 are also possible in this case, which comprise any given combination of a number of the imaging modalities.

In the case shown the medical imaging device 11 is embodied by way of example as a magnetic resonance device 11.

The magnetic resonance device 11 comprises a detector unit formed by a magnet unit 13 with a main magnet 17 for creating a strong and in particular constant main magnetic field 18. In addition the magnetic resonance device 11 has a cylinder-shaped patient receiving area 14 for receiving a patient 15, wherein the patient receiving area 14 is surrounded cylindrically in a circumferential direction by the magnetic unit 13. The patient 15 can be pushed via a patient support facility 16 of the magnetic resonance device 11 into the patient receiving area 14. To this end the patient support facility 16 has a table on which the patient lies, which is arranged movably inside the magnetic resonance device 11. The magnet unit 13 is shielded to the outside via housing cladding 31 of the magnetic resonance device.

The magnet unit 13 also has a gradient coil unit 19 for creating magnetic field gradients, which is used for a spatial encoding during an imaging process. The gradient coil unit 19 is controlled via a gradient control unit 28. Furthermore the magnet unit 13 has a radio-frequency antenna unit 20 which, in the case shown, is embodied as a body coil permanently integrated into the magnetic resonance device 10, and a radio-frequency antenna control unit 29 for exciting a polarization, which is produced in the main magnetic field 18 created by the main magnet 17. The radio-frequency antenna unit 20 is controlled by the radio-frequency antenna control unit 29 and irradiates radio-frequency magnetic resonance sequences into the examination space, which is essentially formed by the patient receiving area 14. The radio-frequency antenna unit 20 is furthermore embodied for receiving magnetic resonance signals, in particular from the patient 15.

For controlling the main magnet 17, the gradient control unit 28 and the radio-frequency antenna control unit 29, the magnetic resonance device 11 has a control unit 24. The control unit 24 centrally controls the magnetic resonance device 11, such as for example the carrying out of a predetermined gradient echo sequence. Control information such as for example imaging parameters, as well as reconstructed magnetic resonance images, can be provided on a provision unit 25, in the present case a display unit 25, of the magnetic resonance device 11 for a user. Moreover the magnetic resonance device 11 has an input unit 26, by which information and/or parameters can be input by the user during a measurement process. The control unit 24 can comprise the gradient control unit 28 and/or radio-frequency antenna control unit 29 and/or the display unit 25 and/or the input unit 26.

The magnetic resonance device 11 furthermore comprises a recording unit 32. The recording unit 32 is formed in the present case by the magnet unit 13 together with the radio-frequency antenna control unit 29 and the gradient control unit 28.

The magnetic resonance device 11 shown can of course comprise further components that magnetic resonance devices usually have. Moreover, a general way in which a magnetic resonance device 11 functions is known to the person skilled in the art, so that a more detailed description of the further components will be dispensed with here.

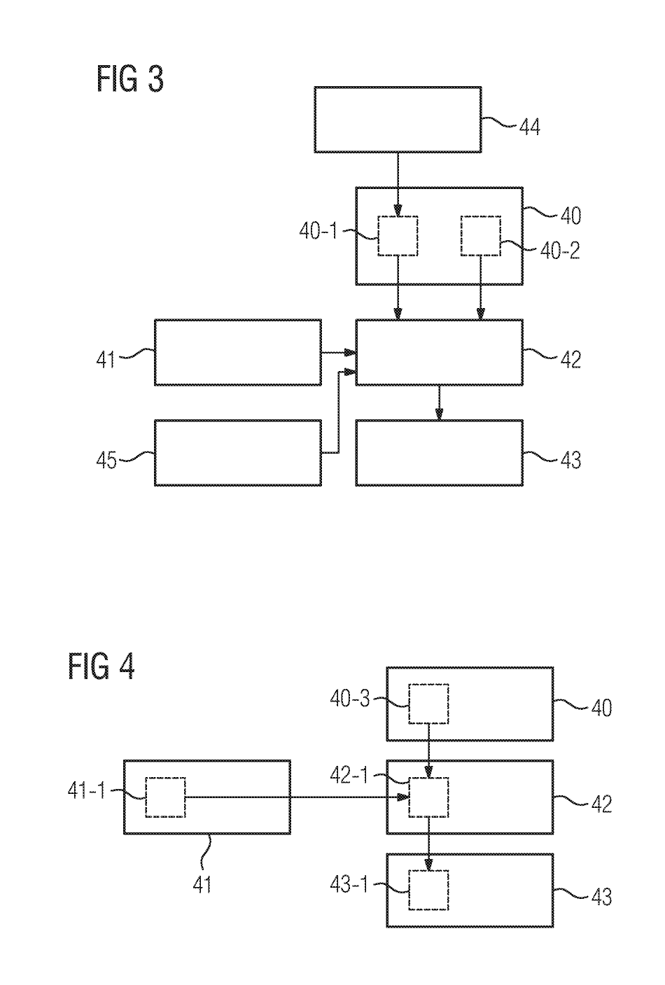

The magnetic resonance device 11 shown comprises a processing unit 27, which comprises a first acquisition unit 33, a second acquisition unit 34, a segmentation unit 35 and a provision unit 36. In this way the processing unit 27 is embodied for carrying out a method in accordance with FIG. 2-3.

For carrying out an embodiment of an inventive method alone, the processing unit 27 advantageously loads medical image data via the second acquisition unit 34 from a database. When an embodiment of the inventive method is carried out by a combination of the magnetic resonance device 11 and the processing unit 27, the second acquisition unit 34 of the processing unit 27 will in particular acquire medical image data, which has been recorded via the recording unit 32 of the magnetic resonance device 11. For this the processing unit 27, in particular the second acquisition unit 34, is advantageously connected to the control unit 24 of the magnetic resonance device 11 in respect of an exchange of data. When the inventive method is carried out by a combination of the magnetic resonance device 11 and the processing unit 27, the segmented organ structure, which is segmented by the processing unit 27, can be provided on the provision unit 25 of the magnetic resonance device 11.

FIG. 2 shows a flow diagram of a first form of embodiment of an inventive method for segmentation of an organ structure of an examination object 15 in medical image data.

In a first method step 40 there is acquisition of genetic data of the examination object 15, which characterizes a morphological variation of the organ structure.

The morphological variation in this case can relate to at least one of the following morphological features of the organ structure:
A size of the organ structure,
A shape of the organ structure,
A volume of the organ structure,
A localization of the organ structure in the body of the examination object.

In a further method step 41 there is an acquisition of medical image data from the examination object 15.

In a further method step 42 there is a segmentation of the organ structure in the medical image data by way of a segmentation algorithm, wherein the genetic data is entered into the segmentation algorithm in addition to the medical image data as input parameters and wherein the segmentation takes account of the morphological variation of the organ structure during the segmentation of the organ structure.

In a further method step 43 there is a provision of the segmented organ structure.

FIG. 3 shows a flow diagram of a second form of embodiment of an inventive method for segmentation of an organ structure of an examination object 15 in medical image data.

The description given below is essentially restricted to the differences from the example embodiment in FIG. 2, wherein, as regards method steps that remain the same, the reader is referred to the description of the example embodiment in FIG. 2. Method steps that essentially remain the same are basically labeled with the same reference numbers.

The form of embodiment of the inventive method shown in FIG. 3 essentially contains the method steps 40, 41, 42, 43 of the first form of embodiment of the inventive method in accordance with FIG. 2. In addition the form of embodiment of the inventive method shown in FIG. 3 comprises additional method steps and substeps. Also conceivable is an alternate execution sequence of the method to FIG. 3, which only has some of the additional method steps and/or substeps shown in FIG. 3. Of course the alternative execution sequence to FIG. 3 can also have additional method steps and/or substeps.

In a further method step 44, in accordance with FIG. 3 it is initially determined which organ structure type is to be segmented in the medical image data. Subsequently the first method step 40, in a first substep 40-1, comprises a check as to whether a genetic variant, which leads to the morphological variation of the organ structure, is present in the genetic data of the examination object. The check is made in accordance with the organ structure type determined. Subsequently a result of the check can be included as an input parameter in the segmentation algorithm and the segmentation algorithm can take account of the result of the check during the segmentation of the organ structure in further method step 42.

In a second substep 40-2 of the first method step 40, the acquisition of the genetic data comprises acquisition of information about the extent to which the organ structure is changed by the morphological variation in its morphology. This information in its turn can be entered into the segmentation algorithm as input parameters and the segmentation algorithm takes account of the information during the segmentation of the organ structure in further method step 42. The first substep 40-1 and the second substep 40-2 of the first method step 40 can of course also be used separately from one another.

In a further method step 45 a further patient-specific feature of the examination object is acquired, wherein the further patient-specific feature is entered into the segmentation algorithm in addition to the medical image data and the genetic data and comprises at least one feature from the following list:
An age of the examination object,
A gender of the examination object,
A size of the examination object,
A weight of the examination object.

The method steps of an embodiment of the inventive method shown in FIG. 2-3 are carried out by the processing unit. To do this, the processing unit comprises the required software and/or computer programs, which are stored in a memory unit of the processing unit. The software and/or computer programs comprise program segments that are designed to carry out embodiments of the inventive method when the computer program and/or the software is executed in the processing unit via a processor unit of the processing unit.

Various possibilities for how the genetic data can be taken into account in an especially suitable manner in the segmentation of the organ structure are described in the example embodiments of FIGS. 4 to 7. The forms of embodiment of the inventive method shown in FIGS. 4 to 7 essentially comprise the method steps 40, 41, 42, 43 of the first form of embodiment of the inventive method in accordance with FIG. 2. It should be pointed out that FIGS. 4 to 7 merely show specific examples for illustration of the inventive method. Further applications of the inventive method, for example based on other genetic variations or for segmentation of other organ structures, are of course conceivable.

FIG. 4 shows a first possible application of an embodiment of the inventive method.

It is precisely in the area of measurement of brain structures (brain morphometry) for diagnosis or early recognition of degenerative brain diseases that the segmentation of the brain structures has a high importance. In this way, in the case shown in FIG. 4 a brain structure is to be segmented. To do this the further method step 41 comprises a substep 41-1, in which medical image data of the brain of the examination object, in particular magnetic resonance image data acquired via a magnetic resonance device, is acquired. Furthermore the segmentation algorithm is to employ an atlas-based segmentation using an atlas, which has at least one atlas organ structure.

The first method step 40, in the case shown in FIG. 4, comprises a substep 40-3, in which genetic data, which is specific for a morphological variation of a brain structure, is acquired. It is known from various publications that there are for example close relationships between the morphology of a brain structure and specific genetic data:
Stein et al. describe that the presence of the intergenetic variant rs7294919 leads to an increase in the volume of the hippocampus by 10 percent greater than the population median (Stein et al., Identification of common variants associated with human hippocampal and intracranial volumes, Nat Genet., 2012, 44(5): 552-561, the entire contents of which are hereby incorporated herein by reference).
Relationships between subcortical brain structures (hippocampus, putamen, nucleus caudatus, intracranial volume) and various gene volumes were recently published in the publication by Hibar et al. (Hibar et al., Common genetic variants influence human subcortical brain structures, Nature, 2015, 520(7546): 224-229, the entire contents of which are hereby incorporated herein by reference).
A general influence of gene characteristics on the size of various areas of the brain has been proved in the study by Thompson et al. (Thompson et al., Genetic influences on brain structure, Nat Neurosci, 2001, 4(12): 1253-1258, the entire contents of which are hereby incorporated herein by reference).

In this way the substep 40-3 comprises a check as to whether a genetic variant, which leads to a morphological variation of the brain structure of the examination object, is present in the genetic data. If this is not the case, then in the further method step 42 the atlas-based segmentation of the brain structure can be carried out as usual.

Otherwise the atlas-based segmentation can be tailored to suit the morphological variation of the brain structure.

To this end the further method step 42 comprises a substep 42-1, in which the atlas organ structure is deformed in accordance with the presence of the morphological variation characterized by the genetic data. The atlas organ structure is adapted in its morphology, for example its size and/or its volume, in particular by comparison with other structures contained in the atlas. If for example the hippocampus is to be segmented and the intergenetic variant rs7294919 described by Stein et al. has been established in the examination object, then the atlas hippocampus structure can be enlarged by 10 percent before being used in the segmentation. The atlas adapted in this way can now take account in an especially suitable manner of the enlargement of the hippocampus by comparison with the population median and thus lead to especially exact results in the segmentation of the hippocampus. For example through the adaptation of the size of the hippocampus to the real size of the hippocampus in the medical image data, a registration of the atlas to the medical image data can be simplified.

As an alternative the process is also conceivable in which, in substep 42-1, the atlas used for the segmentation will be selected from a set of atlases in accordance with the presence of the morphological variation characterized by the genetic data. Subsequently a deformation of the atlas organ structure is still always possible.

The further method step 43 comprises a substep 43-1, in which the segmented brain structure is provided. For example a display of the brain of the examination object with a color-coded representation of the segmented brain structure is conceivable. As an alternative or in addition a measurement of the segmented brain structure is conceivable, wherein the results of the measurement can be output in a report.

FIG. 5 shows a second possible application of an embodiment of the inventive method.

In the case shown in FIG. 5 the prostate of the examination object is to be segmented. To this end the further method step 41 comprises a substep 41-2, in which medical image data, in particular magnetic resonance image data, of the prostate of the examination object is acquired. Furthermore the segmentation algorithm is to use an artificial neural network trained for the segmentation of the organ structure.

Descazeaud et al. show that gene expression signatures of a patient have a close relationship to the volume of the prostate. For example it has been found that the gene TEMFF2 is also regulated higher with the presence of a larger prostate (Descazeaud et al., BPH gene expression profile associated to prostate gland volume, Diagn Mol Pathol, 2008, 17(4): 207-213, the entire contents of which are hereby incorporated herein by reference).

The first method step 40, in the case shown in FIG. 5, thus shows a substep 40-4, in which genetic data, which is specific for a morphological variation of the prostate, is acquired. In this way the regulation of the gene TEMFF2 is examined in substep 40-4 of FIG. 5. When a usual regulation of this gene is recognized, then in further method step 42 the segmentation can be carried out as usual. With an increased regulation of this gene the segmentation of the prostate can be tailored in a suitable manner to the increased size of the prostate to be expected.

To this end the further method step 42 comprises a substep 42-2, which is changed for the artificial neural network used for the segmentation in accordance with the presence of the morphological variation characterized by the genetic data. A measure of the high regulation of the gene TEMFF2 can be entered directly as an indication for a size of the prostate to be expected into the segmentation via the artificial neural network. The artificial neural network can be adapted with the presence of an increased regulation of this gene such that it is especially suited to segmentation of especially large prostate glands.

It is also conceivable for the artificial neural network used for the segmentation to be selected in accordance with the presence of the morphological variation characterized by the genetic data. In this case a first artificial neural network and a second artificial neural network are available for the segmentation of the organ structure, wherein the first artificial neural network has been trained via a first training collective, which has the genetic variant, and the second artificial neural network has been trained via a second training collective which does not have the genetic variant, wherein in accordance with the result of the check, the first artificial neural network or the second artificial neural network is used for the segmentation of the organ structure.

In the present case the first training collective can have a higher regulation of the gene TEMFF2 than the first training collective. In this way the first artificial neural network is in particular better suited to the segmentation of larger prostate glands than the second artificial neural network.

Finally the application case is conceivable that initially a rough segmentation of the prostate, for example via the artificial neural network, is carried out. The rough segmentation can then be refined by way of suitable boundary conditions. The influence of the genetic data on the size of the prostate to be expected can be used in the rough and/or in the fine segmentation as additional input information or represent an additional boundary condition in the refinement of the segmentation.

The further method step 43 comprises a substep 43-2, in which the segmented prostate is provided. A volume of the segmented prostate can also be calculated as a measure for the presence of a prostate hyperplasy.

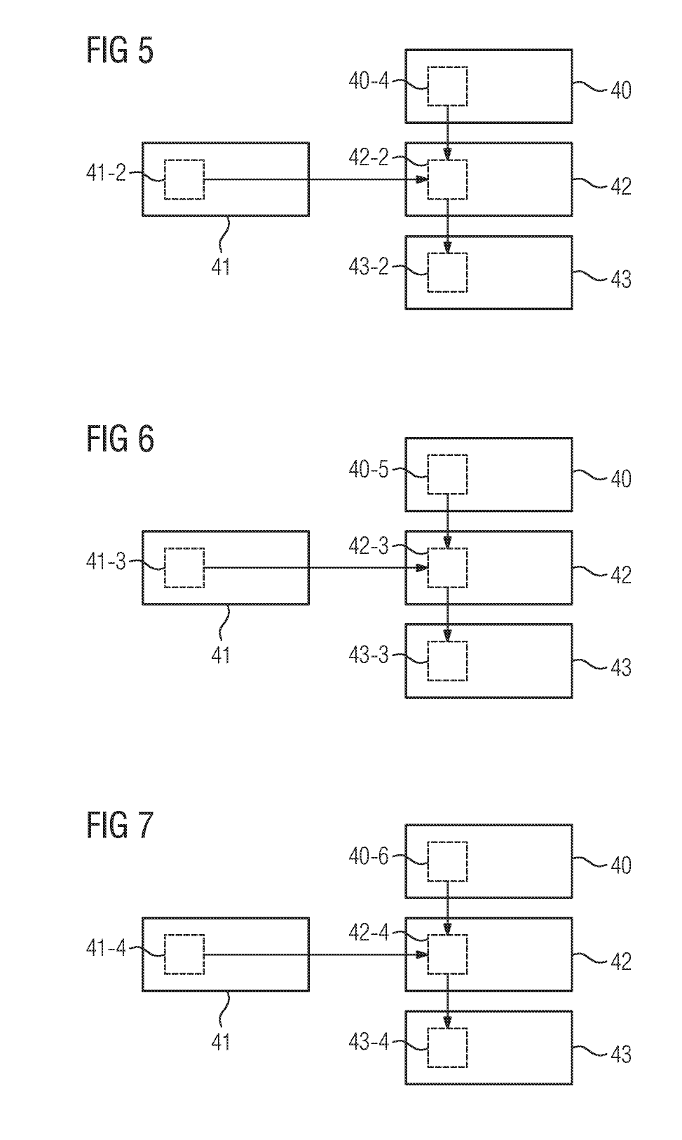

FIG. 6 shows a third possible application of an embodiment of the inventive method.

In some application cases (e.g. in image-based patient checking or as a basis for subsequent post-processing of the medical image data) it can be sensible to segment the entire body volume of the examination object. In this way, in the case shown in FIG. 6, the entire body volume of the examination object is to be segmented. To this end the further method step 41 comprises a substep 41-3, in which medical image data of the entire body or of an axial body section of the examination object is acquired. The segmentation algorithm should use a model-based segmentation employing a body model.

Heid et al. show that the waist-hip ratio (the ratio between measurement of waist and hips) has a close relationship with various gene variants (Heid et al., Meta-analysis identifies 13 new loci associated with waist-hip ratio and reveals sexual dimorphism in the genetic basis of fat distribution, Nat Genet, 2010, 42(11): 949-960, the entire contents of which are hereby incorporated herein by reference). The first method step 40, in the case shown in FIG. 6, has a substep 40-5, in which genetic data, which is specific for a morphological variation of the waist-hip ratio, is acquired.

Accordingly the gene variant linked to the waist-hip ratio, in addition to the size and the weight of the patient, can represent a sensible input parameter for the segmentation of the entire body volume in substep 42-3 of the further method step 42. For example, in accordance with the waist-hip ratio predicted by the gene variant, a suitable model for the body segmentation can be selected and/or an already existing model can be suitably adapted. If the result of the check is that the examination object has a normal waist-hip ratio, since it is not affected by the gene variant, then the body segmentation can be carried out as usual.

The further method step 43 comprises a substep 43-3, in which the segmented body volume of the examination object is provided, in particular for further processing.

FIG. 7 shows a fourth possible application of an embodiment of the inventive method.

In the segmentation of the heart or of a heart structure or in the recognition of landmarks in the heart (e.g. for a subsequent automatic measurement planning) the general size of the heart can represent a sensible input parameter or a boundary condition for the segmentation. In this way, in the case shown in FIG. 7, a heart structure, namely the left ventricle of the examination object, is to be segmented. To this end the further method step 41 comprises a substep 41-4, in which medical image data of the heart of the examination object is acquired. Furthermore the segmentation algorithm should employ a region growing method using a boundary condition for the segmentation of the left ventricle. As an alternative the use of a random walker method would also be conceivable.

If the heart is especially dilated (e.g. in dilated cardiomyopathy) conventional segmentation algorithms can no longer function. Gene information of the patient can point to such a dilation, such as e.g. described in the publication by Lakdawala et al. (Lakdawala et al, Genetic Testing for Dilated Cardiomyopathy in Clinical Practice, J Card Fail, 2012, 18(4): 296-303, the entire contents of which are hereby incorporated herein by reference). The first method step 40, in the case shown in FIG. 7, thus shows a substep 40-6, in which genetic data, which is specific for a dilatation of the heart, is acquired. In this way the substep 40-6 comprises a check as to whether a genetic variant, which leads to a dilatation of the heart, is present in the genetic data. If this is not the case, then the segmentation can be carried out as usual in further method step 42. Otherwise the segmentation of the heart structure can be tailored in a suitable manner to the dilatation of the heart.

To this end the further method step 42 comprises a substep 42-4, in which the segmentation of the left ventricle is suitably tailored to the dilatation of the heart. The boundary condition for the region growing method (or as an alternative for the random walker method) is determined here in accordance with the dilatation of the heart characterized by the genetic data. In this way, for a strong dilation of the heart to be expected, the boundary condition, which describes a maximum size of the left ventricle, can be selected higher.

The further method step 43 comprises a substep 43-4, in which the segmented heart structure is provided. For example the left ventricle will be shown highlighted in a representation of the heart.

Although the invention has been illustrated and described in greater detail by the preferred example embodiments, the invention is not restricted by the disclosed examples however and other variations can be derived herefrom by the person skilled in the art, without departing from the scope of protection of the invention.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for segmentation of an organ structure of an examination object in medical image data, comprising:
acquiring genetic data of the examination object, characterizing a morphological variation of the organ structure;
acquiring medical image data from the examination object;
segmenting the organ structure in the medical image data using a segmentation algorithm, wherein the genetic data is entered into the segmentation algorithm in addition to the medical image data, as input parameters, and wherein the segmentation algorithm takes account of morphological variation of the organ structure during the segmenting of the organ structure, to proce a segmented organ structure; and
provisioning the segmented organ structure.

2. The method of claim 1, wherein the morphological variation relates to at least one of a morphological features of the organ structure including:
a size of the organ structure,
a shape of the organ structure,
a volume of the organ structure, and
a localization of the organ structure in a body of the examination object.

3. The method of claim 1, wherein the acquiring of the genetic data comprises checking whether a genetic variant, which leads to the morphological variation of the organ structure, is present in the genetic data of the examination object, wherein a result of the checking is entered into the segmentation algorithm as input parameters and the segmentation algorithm takes account of a result of the checking during the segmentation of the organ structure.

4. The method of claim 3, further comprising:
determining, an organ structure type of the organ structure, for the segmenting in the medical image data, and wherein the checking is made in accordance with the organ structure type determined in the determining.

5. The method of claim 1, wherein the acquiring of the genetic data comprises
acquiring information as to an extent to which the organ structure is changed by the morphological variation in a morphology of the organ structure, wherein the information acquired, in the acquiring of the genentic information, is entered into the segmentation algorithm as input parameters and wherein the segmentation algorithm takes account of the information acquired during the segmenting of the organ structure.

6. The method of claim 1, wherein the segmentation algorithm employs an atlas-based segmentation using an atlas, and wherein the atlas used for the segmentation is selected from a set of atlases in accordance with a presence of the morphological variation characterized by the genetic data.

7. The method of claim 1, wherein the segmentation algorithm employs an atlas-based segmentation using an atlas, wherein the atlas includes at least one atlas organ structure and wherein the at least one atlas organ structure is deformed in accordance with a presence of the morphological variation characterized by the genetic data.

8. The method of claim 1, wherein the segmentation algorithm employs a region growing method or a random walker method using a boundary condition for the segmenting of the organ structure, and wherein the boundary condition is defined in accordance with the morphological variation characterized by the genetic data.

9. The method of claim 1, wherein the segmentation algorithm employs an artificial neural network trained for the segmenting of the organ structure, and wherein the artificial neural network used for the segmenting is at least one of selected and changed in accordance with a presence of the morphological variation characterized by the genetic data.

10. The method of claim 3, wherein a first artificial neural network and a second artificial neural network are available for the segmenting of the organ structure, wherein the first artificial neural network has been trained via a first training collective, including the genetic variant, and the second artificial neural network has been trained via a second training collective, not including the genetic variant, and wherein, in accordance with the result of the checking, the first artificial neural network or the second artificial neural network is selected to be used for the segmenting of the organ structure.

11. The method of claim 1, wherein a further patient-specific feature of the examination object is acquired, wherein the further patient-specific feature is entered into the segmentation algorithm, in addition to the medical image data and the genetic data, and comprises at least one of:
an age of the examination object,
a gender of the examination object,
a size of the examination object, and
a weight of the examination object.

12. The method of claim 1, wherein the organ structure to be segmented is one of:
a brain structure of the examination object,
a prostate of the examination object, or
a heart structure of the examination object.

13. A processing unit, comprising:
at least one processing module, embodied to carrying out at least:
acquiring genetic data of an examination object, characterizing a morphological variation of an organ structure;
acquiring medical image data from the examination object;
segmenting the organ structure in the medical image data using a segmentation algorithm, wherein the genetic data is entered into the segmentation algorithm in addition to the medical image data, as input parameters, and wherein the segmentation algorithm takes account of morphological variation of the organ structure during the segmenting of the organ structure, to proce a segmented organ structure; and
provisioning the segmented organ structure.

14. A medical imaging device, comprising
the processing unit of claim 13.

15. A non-transitory computer program product, directly loadable into a memory of a programmable processing unit, including program code segments for carrying out the method of claim 1, when the computer program product is executed in the programmable processing unit.

16. The method of claim 2, wherein the acquiring of the genetic data comprises checking whether a genetic variant, which leads to the morphological variation of the organ structure, is present in the genetic data of the examination object, wherein a result of the checking is entered into the segmentation algorithm as input parameters and the segmentation algorithm takes account of a result of the checking during the segmentation of the organ structure.

17. The method of claim 16, further comprising:
determining, an organ structure type of the organ structure, for the segmenting in the medical image data, and wherein the checking is made in accordance with the organ structure type determined in the determining.

18. The method of claim 3, wherein the acquiring of the genetic data comprises
acquiring information as to an extent to which the organ structure is changed by the morphological variation in a morphology of the organ structure, wherein the information acquired, in the acquiring of the genentic information, is entered into the segmentation algorithm as input parameters and wherein the segmentation algorithm takes account of the information acquired during the segmenting of the organ structure.

19. The method of claim 3, wherein the segmentation algorithm employs an atlas-based segmentation using an atlas, and wherein the atlas used for the segmentation is selected from a set of atlases in accordance with a presence of the morphological variation characterized by the genetic data.

20. The method of claim 3, wherein the segmentation algorithm employs an atlas-based segmentation using an atlas, wherein the atlas includes at least one atlas organ structure and wherein the at least one atlas organ structure is deformed in accordance with a presence of the morphological variation characterized by the genetic data.

21. The method of claim 3, wherein the segmentation algorithm employs a region growing method or a random walker method using a boundary condition for the segmenting of the organ structure, and wherein the boundary condition is defined in accordance with the morphological variation characterized by the genetic data.

22. The method of claim 3, wherein the segmentation algorithm employs an artificial neural network trained for the segmenting of the organ structure, and wherein the artificial neural network used for the segmenting is at least one of selected and changed in accordance with a presence of the morphological variation characterized by the genetic data.

23. The method of claim 9, wherein a first artificial neural network and a second artificial neural network are available for the segmenting of the organ structure, wherein the first artificial neural network has been trained via a first training collective, including the genetic variant, and the second artificial neural network has been trained via a second training collective, not including the genetic variant, and wherein, in accordance with the result of the checking, the first artificial neural network or the second artificial neural network is selected to be used for the segmenting of the organ structure.

24. A non-transitory computer-readable medium storing program segments, readable in and executable by a computer unit, to carry out the method of claim 1 when the program segments are executed by the computer unit.
